(19) United States
(12) Patent Application Publication
(10) Pub. No.: US 2015/0059905 A1
(43) Pub. Date: Mar. 5, 2015

(54) HYBRID MARMAN CLAMP DESIGN

(71) Applicant: Caterpillar Inc., Peoria, IL (US)

(72) Inventors: Douglas Edward Jones, Lafayette, IN (US); Aaron Lee Hartzler, Lafayette, IN (US); Jeremy Daniel Byrd, West Lafayette, IN (US); Keith William Mellencamp, Lafayette, IN (US)

(73) Assignee: Caterpillar Inc., Peoria, IL (US)

(21) Appl. No.: 14/018,834

(22) Filed: Sep. 5, 2013

(51) Int. Cl. F16L 19/065

(52) U.S. Cl. CPC F16L 19/065
USPC 138/109

(57) ABSTRACT

A pipe assembly for an exhaust system having a pipe with first end and a second end. The first end of the pipe having a shoulder with an inclined lip. The inclined lip facing outward from the first end of the pipe. Further, the pipe assembly includes a corrugated conduit having a collared end. The collared end abuts the inclined lip on the first end of the pipe thereby forming a joint with the pipe. Further, a shim ring is disposed on the joint. Furthermore, the assembly includes a clamp configured to circumference the joint and compresses the shim ring there between to form a seal at the joint.

### TECHNICAL FIELD

The present invention generally relates to a pipe assembly for an exhaust system used in vehicles and, more particularly, to a pipe assembly having corrugated conduit coupled to a rigid pipe with a clamp and utilizing a shim ring to provide a connection there between.

### BACKGROUND

Vehicles such as trucks, buses, and other similar automobiles are equipped with an exhaust system to convey hot exhaust gases and byproducts of combustion from an internal combustion engine to the ambient atmosphere. The exhaust system utilizes various emission control devices, such as mufflers, resonators, catalytic converters, and the like. The emission control devices are connected to form the exhaust system. Connections for connecting the control devices are made using a corrugated conduit, and joints are sealed using different joint types, such as full marman, half marman, bolted, and slip fit joint.

The exhaust system is subjected to thermal stresses associated with the handling of hot exhaust gases and vibration stresses from vibration sources such as the engine and the operation of the vehicle such a digging or excavating. As the exhaust system are subject to such stresses, the joints leak. The leakage can lead to eroding of manifold, which may contribute to carbon monoxide in passenger cabin. While various solutions have been developed to provide arrangements that can solve the problem cited above, there is still room for development. Thus, a need persists for further contribution in this area of technology.

The present disclosure is directed towards the problem stated above.

### SUMMARY

In an embodiment, a pipe assembly for an exhaust system is provided. The pipe assembly includes a pipe having a first end and a second end. The first end of the pipe includes a shoulder having an inclined lip. The inclined lip is facing outward from the first end of the pipe. The second end of the pipe is coupled to an internal combustion engine. Further, the pipe assembly includes a corrugated conduit. The corrugated conduit includes a collared end. The collared end abuts the inclined lip on the first end of the pipe thereby forming a joint with the pipe. Further, a shim ring is disposed on the joint. The shim ring is circumferentially contractible. Furthermore, a clamp is provided. The clamp is configured to circumference the joint and compresses the shim ring there between to form a seal at the joint.

Other features and advantages of the invention will become apparent to those skilled in the art, upon review of the following detailed description and drawings.

### BRIEF DESCRIPTION OF THE DRAWINGS

FIG. 1 is a sectional view of a pipe assembly for an exhaust system in accordance with an embodiment of the present disclosure.

FIG. 2 is an exploded view of a pipe assembly for an exhaust system in accordance with an embodiment of the present disclosure.

### DETAILED DESCRIPTION

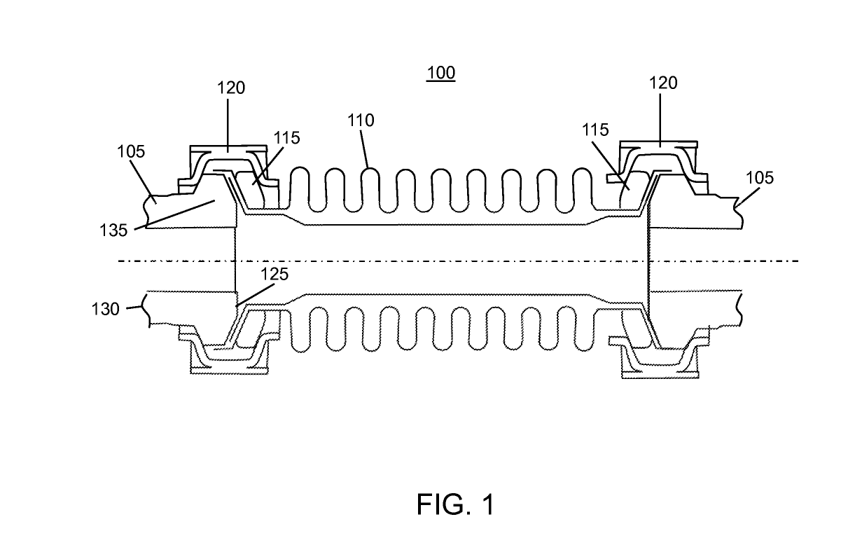

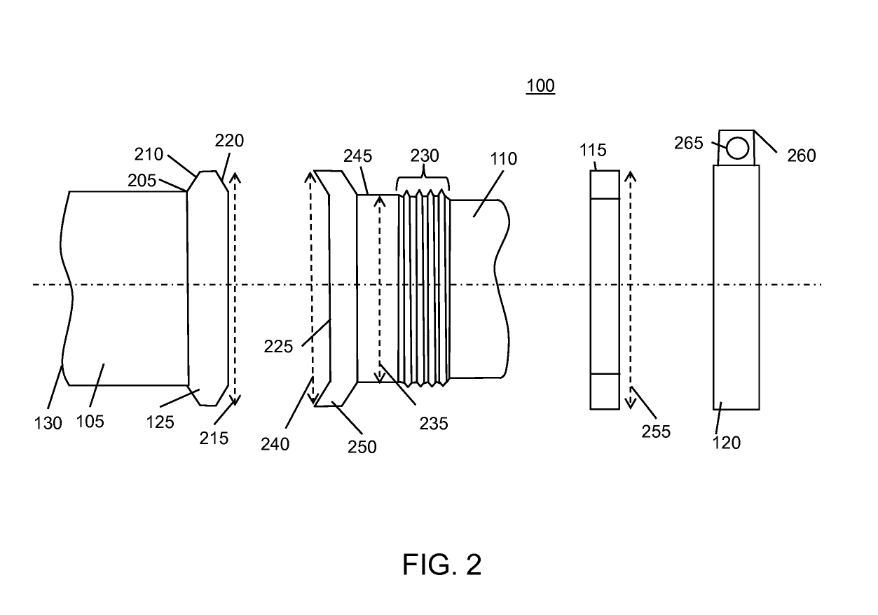

Detailed embodiments of the present disclosure are described herein with reference to FIG. 1 and FIG. 2. The specific structural and functional details disclosed herein are intended to be exemplary and should not be interpreted as limiting the disclosure.

FIG. 1 illustrates a sectional view of a pipe assembly 100 for an exhaust system in accordance with an embodiment of the disclosure. The pipe assembly 100 comprises a pipe 105, a corrugated conduit 110, a shim ring 115, and a clamp 120. The pipe 105, the corrugated conduit 110, the shim ring 115, and the clamp 120 have a circular transverse cross sectional configuration. The pipe assembly 100 couples the pipe 105 with emission control devices (not shown in FIG. 1). For example, the pipe assembly 100 can include the pipe 105 that can be used to connect to an end section of an exhaust manifold or a mouth piece of an emission control/exhaust after treatment device. In an embodiment, pipe 105 can have a first end 125 and a second end 130. The first end 125 can be configured to be connected to a corrugated pipe, such as corrugated conduit 110. The first end 125 of the pipe 105 has shoulder 135, such that outer end of the shoulder 135 has an inclined lip facing outward. In other words, the outer end of the shoulder 135 has a taper section starting from the outer diameter of the pipe 105 and ends before the inner diameter. Hence the outer section of the shoulder 135 is inclined to form a lip.

The second end 130 of the pipe can be connected to an exhaust treatment device, a tail pipe, a muffler, or any other emission control device. It can be contemplated that the second end 130 of the pipe 105 can be connected or joined or an integral part of any component of an exhaust system. For example, the end section of an exhaust manifold can be designed to have mouthpiece section similar to the first end 125.

Further, the pipe assembly 100 is shown to include a corrugated conduit 110. The corrugated conduit 110 can be describe as a conduit with a bellow shaped member having alternate crest and troughs on the periphery. The ends of the corrugated conduit 110 are collared to conform to the shape of the inclined lip of the pipe 105. In other words, the collared ends of the corrugated conduit 110 are designed to match with lip design on the first end 125. It is to be noted that both the pipe 105 and the corrugated conduit 110 can be hollow cylindrical pipe to accommodate the flow of fluid or gases, such as exhaust gases, in an embodiment of the current disclosure.

The shim ring 115 can be a tapered or flat ring. In other words, the shim ring 115 can be a wedge shaped ring made of suitable material such as latex, resilient rubber, laminated stacked foil of metal. In general shim ring 115 can be a ring that can be configured to contract circumferentially.

The clamp 120 can be an annular band shape element that can be disposed circumferentially over a cylinder and tightened around the cylinder. In other words, the clamp 120 can be positioned over a cylindrical body and can be compressed over the cylindrical body to form a seal or apply pressure from outside. The assembly of the components in the present disclosure, including the placement and juxtaposition of components, is further illustrated in FIG. 2.

FIG. 2 is an exploded view of the pipe assembly 100 for an exhaust system in accordance with an embodiment of the present disclosure. The pipe assembly 100 is described in conjunction with the elements described in FIG. 1. FIG. 2 illustrates the exploded view of the pipe 105, the corrugated conduit 110, the shim ring 115 and the clamp 120.

As described in FIG. 1, the pipe 105 is cylindrical in shape with two ends, the first end 125 and the second end 130. The first end 125, at point 205 is an open end with a shoulder 210 and an outside diameter 215. Further, the shoulder 210 present on the first end 125 of the pipe 105 has an inclined lip 220. In other words, the shoulder can be a circumferential rim with a tapered face at the outer end of the pipe 105.

The corrugated conduit 110 comprises an open end 225. The corrugated conduit 110 further comprises a corrugated section 230 with a series of corrugations spaced at a regular interval. The corrugated conduit 110 can be of a suitable internal diameter 235 to accommodate the flow of gases such as exhaust gases from an engine. Also, at the open end 225, the external diameter 240 of the corrugated conduit 110 forms a collar 250. The corrugated conduit 110 is also shown to include a neck portion 245 located between open end 225 and the corrugated section 230. In other words, the corrugated conduit 110 has a circular transverse cross-sectional configuration, with the neck portion 245 having a smooth cylindrical surface between the open end 225 and the corrugated section 230. The neck portion 245 of the corrugated conduit 110 proceeds into the collar 250, with the external diameter 240.

The collar 250 can be configured to abut to the inclined lip 220 of the pipe 105. It is to be noted that the outside diameter 215 of the pipe 105 is equal to or less than the external diameter 240 of the corrugated conduit 110, such that the pipe 105 is adapted to be received within the open end 225 of the corrugated conduit 110 in a sealed manner.

FIG. 2 is also shown to include the shim ring 115. The shim ring 115 can be a cylindrical band with circular edges. The shim ring 115 has a circular transverse cross-sectional configuration with an outside diameter 255. The outside diameter 255 of the shim ring 115 can be larger than the internal diameter 235 of the corrugated conduit 110 such that the shim ring 115 can be adapted to fit over the neck portion 245 of the corrugated conduit 110. In one embodiment, the shim ring 115 can also be placed over the neck portion 245, abutting the collar 250 of the corrugated conduit 110. The shim ring 115 can be made of a material that can withstand hot exhaust gases temperature. For example, the shim ring 115 may be made of steel. It will be evident to a person with ordinary skills in the art that the above-mentioned example nowhere limits the invention to the use of steel for manufacturing the shim ring 115. In an embodiment, the shim ring 115 can be made from any material that can withstand high pressure and temperature condition existing in a known in the art exhaust system.

As described above, the shim ring 115 can be disposed circumferentially around the neck portion 245 of the corrugated conduit 110. Further, the collar 250 of the corrugated conduit 110 can be abutted with the inclined lip 220 to cause a joint between the pipe 105 and the corrugated conduit 110.

Further, the joint between the corrugated conduit 110 and the pipe 105, including the shim ring 115, is implemented by the clamp 120. The clamp 120 has an annular band shape structure. In other words, the clamp 120 can be flat metal band that can be configured to circumference around the joint. Further, a pair of ears 260 with an aperture 265 are integrated and extended from the clamp 120 for receiving a suitable mechanical fastener, such as a nut and bolt (not shown in the FIG.) that may be used to tighten to draw the pair of ears 260 together. In other words, the clamp 120 can be a broken circumferential metal band than can have a pair of lobes or ears 260 extend at the broken end. The pair of lobes or ears 260 can have the aperture 265, such that the broken ends can be drawn together by tightening the pair of ears 260 and thus hold the corrugated conduit 110 around the pipe 105. In an embodiment, the pair of ears 260 of the clamp can be drawn close, to compress the shim ring 115 located under the clamp 120.

Hence, the pipe 105 is received within the corrugated conduit 110 such that the collar 250 of the corrugated conduit 110 abuts to the inclined lip 220 of the pipe 105. The shim ring 115 is sandwiched between the corrugated conduit 110 and the clamp 120, and is thus compressed when clamp 120 is tightened thereby forming an effective seal. The shim ring 115 thus substantially fills in the area or gap between the clamp 120 and the corrugated conduit 110, and acts as a wedge. The shim ring 115 redistributes the load from the clamp 120 over a larger area of the corrugated conduit 110. This prevents high load concentrations due to the potential line contact of the clamp 120 on the corrugated conduit 110. Thus, a secure and gas tight seal is formed at the joint, with the clamp 120 providing a secure mechanical connection and the shim ring 115 providing an effective seal.

In the embodiments discussed above, the disclosure provides a clamp design as a solution for providing gas-tight seal joints. The clamp design essentially replicates a pseudo half marman clamp using the manifold end connections configured for a full marman joint. The shim ring 115 can be inserted under the clamp 120 to provide the sealing force that a half marman joint would typically provide.

### INDUSTRIAL APPLICABILITY

The present disclosure provides an improved clamp design that applies generally to an exhaust system used in vehicles. The present disclosure finds specific applicability in connecting an exhaust manifold/pipe with a corrugated conduit 110, which is further connected to other emission control devices. When in operation, the exhaust manifold/pipe collects exhaust from an engine (not shown in the FIG.) and directs the exhaust along the corrugated conduit 110 though other emission control devices or into the atmosphere.

Corrugated conduits are needed along the way to account for vibration and assembly. The connection between various components and corrugated conduit 110 may be made using the clamp design disclosed in the embodiments above. Other joints, for example a full marman joint, are not always as robust as desired and may lead to exhaust leakage, especially in a high temperature exhaust environment. The disclosed clamp design discussed in the disclosure provides a more rigid and stable joint to be used in the exhaust assembly. The disclosure provides a retrofit to fix leaking exhaust manifolds. The disclosed joint type replicates a pseudo half marman clamp using the existing components that were configured for a full marman joint.

The disclosed clamp design also acts as a solution for transforming existing full marman joint to a hybrid half marman joint. The transformation can be done by using same components designed for a full marman joint. An embodiment of the present disclosure uses the shim ring 115 on the corrugated conduit 110 under the clamp 120. The shim ring 115 redistributes the load from the clamp 120 over the larger area of the corrugated conduit 110, thereby preventing high load concentrations.

It should be understood that the above description is intended for illustrative purposes only and is not intended to limit the scope of the present disclosure in any way. Thus, those skilled in the art will appreciate that other aspects of the disclosure can be obtained from a study of the drawings, the disclosure, and the appended claim.

What is claimed is:

1. A pipe assembly for an exhaust system, the pipe assembly comprising:
a pipe having a first end and a second end, the first end comprising a shoulder having an inclined lip facing outward from the first end of the pipe, and the second end configured to be coupled to an internal combustion engine;
a corrugated conduit comprising a collared end, wherein the collared end abuts the inclined lip on the first end of the pipe forming a joint with the pipe;
a shim ring disposed on the joint, wherein the shim ring is circumferentially contractible; and
a clamp configured to circumference the joint and compress the shim ring there between to form a seal at the joint.
